(19) United States
(12) Patent Application Publication
(10) Pub. No.: US 2008/0173211 A1
(43) Pub. Date: Jul. 24, 2008

(54) Constant Contact Side Bearing for railroad freight cars

(76) Inventor: James S. Kennedy, Zelienople, PA (US)

Correspondence Address: BUCHANAN INGERSOLL & ROONEY PC, P.O. BOX 1404, ALEXANDRIA, VA, 22313-1404, US

(21) Appl. No.: 12/005,995

(22) Filed: Dec. 28, 2007

Related U.S. Application Data
(60) Provisional application No. 60/878,276, filed on Jan. 3, 2007.

(51) Int. Cl. B61F 5/14; F16C 17/04

(52) U.S. Cl. 105/199.3; 384/423

(57) ABSTRACT

A railway freight car constant contact side bearing positionable between a railway vehicle body and a wheeled truck supporting said railway freight car body with a housing or cage and a cap on such cage to engage the wear plate on the car body. The cage houses a plurality of springs having at least one metallic spring and at least one elastomer spring; such springs combine to support and dampen the forces of said vehicle body.

### BACKGROUND

The Constant Contact Side Bearing (CCSB) is a common device for limiting undesirable motion in railroad freight cars. The CCSB typically consists of a contained resilient member (such as, for example, an elastomer mechanical spring, etc.) attached to the truck and maintaining engagement with the freight car body. When the car experiences roll motion due to curving or track irregularities, the CCSB can dissipate a portion of the resulting energy through vertical compression of the resilient member, restoring the system to equilibrium. In addition, the CCSB is capable of controlling hunting by resisting rotation of the truck via frictional sliding between the freight car body wear plate and the CCSB.

Based on these considerations, it is desirable that the CCSB provide consistent and sustainable vertical and longitudinal damping characteristics over a wide range of temperatures and operating conditions for the successful operation of a railcar. Historically, CCSBs with elastomer springs have been the device of choice to meet these rigorous demands of rail service (refer to U.S. Pat. Nos. 3,957,318, 6,092,470 and 6,862,999 herein incorporated by reference). The primary benefits of utilizing elastomer springs includes its excellent damping properties, predictable performance, energy storage per unit volume resulting in smaller footprints, and meeting the design parameter for the vertical and longitudinal stiffness characteristics. However, elastomer springs are subject to compression set and, if not designed properly, they can be susceptible to thermal degradation. As a result, in recent years there has been a growing interest in a CCSB that incorporates metallic compression springs. U.S. Pat. No. 5,806,435 shows special long travel metallic springs. Certainly, steel springs offer potential benefits of lower compression set and improved resistance to thermal degradation. But, they possess insufficient vertical damping (refer to FIG. 1), have less predicable fatigue life, properties are typically unidirectional, and require a much larger footprint to generate equivalent loads, when compared to elastomer springs.

### SUMMARY OF THE INVENTION

Therefore, a “hybrid” CCSB consisting of metallic spring or springs in combination with elastomer spring or springs can be used in order to provide more balanced performance by maximizing the advantages and minimizing the disadvantages of both types of springs. For example, metallic steel springs have poor vertical damping, but good resistance to thermal degradation. Whereas, elastomer springs have excellent vertical damping and lower resistance to thermal degradation. By creating a “hybrid” side bearing consisting of metallic and elastomer springs in the proper ratio, one can create a CCSB with a good balance of vertical damping and resistance to thermal degradation. The following table provides an estimate of one such embodiment of a CCSB with metallic, elastomer and hybrid springs.

| Performance | Metallic Spring | Elastomer Spring | Hybrid Spring |
|---|---|---|---|
| Criteria | CCSB | CCSB | CCSB |
| Thermal Resistance | E | G | V |
| Vertical Damping | P | E | V |
| Preload Retention | E | G | V |
| Compression Set | E | G | V |
| Fatigue Life | F | V | G |
| Predictable | G | E | V |
| Degradation | | | |
| Cost | F | V | G |
| Lower Stresses | F | V | G |

E = Excellent V = Very Good G = Good F = Fair P = Poor

By this table, it can be seen that by combining metallic and elastomer springs, the hybrid spring CCSB integrates the advantageous properties of each spring type to minimize and/or improve upon the shortcomings, especially in the area of thermal resistance, vertical damping and preload retention, which are essential to the successful performance of a CCSB.

Some of the potential benefits of the hybrid spring are as follows.

The metallic spring can have a higher thermal conductivity than an elastomer and can provide a path for drawing heat away from the wear cap due to friction and thereby reducing the thermal damage to the elastomeric spring.

By sharing the preload between metallic and elastomer springs, each spring can be subjected to lower stresses and thereby reduces the chance of the springs failing.

The impact of any degradation of the elastomer spring can be reduced since the entire load is not being generated by the elastomer or vice versa. For example, if 50% of the preload is generated by the metallic spring and 50% by the elastomer spring, then any preload loss in the elastomer will impact only half of the total preload, resulting in a 50% reduction in potential preload loss.

The elastomer spring will provide the much needed damping properties over the metallic only spring designs. The elastomer spring can be a backup in case of failure in the metallic spring and vice versa. An elastomer spring provides a more gradual decrease in performance over time which is more conducive to a regular maintenance program to maintain acceptable performance.

The CCSB can be less expensive if a mix of metallic and elastomer springs are used as opposed to an all metal spring design.

The very small compression set taken by a metallic spring can help offset the set experienced by an elastomer spring. On the other hand, an elastomer spring intrinsically possesses the ability to provide a minimum amount of creep (a form of stress relaxation). This is advantageous in a constant contact side bearing because it helps the freight vehicle body to settle down on the side bearings to the appropriate setup height and maintain the proper balance of load at the centerbowl/centerplate and an interface. This is especially useful in a newly built freight car or when the freight car is not loaded.

The following is a description of some embodiments of the invention. The hybrid spring constant contact side bearing (CCSB) would typically consist of a housing which attaches to the truck, a wear cap that sits above the housing and contacts the body side bearing wear plate on the underside of the car body, and at least one resilient member that fits inside the housing and below the wear cap and is loaded in compression. In the hybrid spring CCSB, the resilient member would consist of the combination of at least one metallic spring and at least one elastomer member or spring. Designs of this type are shown in FIG. 2 and FIG. 3. However, there are many variations and modifications of this basic design that could prove to be useful.

The CCSB can be designed to provide either standard travel or extended (long) travel in terms of vertical deflection of the side bearing. The CCSB can structure to limit vertical travel (deflection) by interaction of existing components, such as the wear cap and housing, or a separate additional component. This solid stop can engage prior to the solid height or travel limit of the metallic and/or elastomer spring.

The resilient member can consist of any of the following or other structures:

Metallic spring and one or more elastomer springs as separate components that nest within each other in the following manner such as, for example, the metallic spring or springs inside the elastomer spring (refer to FIGS. 2a, b, c, d); the elastomer spring within the metallic spring or springs (refer to FIGS. 3a, b, c, d); a combination of stacking alternating metallic spring and elastomer springs.

One embodiment can use a metallic spring encapsulated within an elastomer material (refer to FIGS. 4a, b, c, d) where the metallic spring can be positioned either centered, eccentric or a combination of the two within the elastomer material with respect to vertical and through the cross-section or the metallic spring can be attached to the elastomer mechanically, chemically (bonded) or a combination of the two; or the free surfaces of the elastomer material encapsulating the metallic spring could be smooth (refer to FIGS. 4a, b, c, d) or shaped to match the contour of the spring geometry (refer to FIGS. 5a, b, c, d).

The metallic spring(s) and elastomer spring(s) can be placed in series (linked end to end as shown in FIGS. 6a, b, c, d) parallel or concentric (refer to FIG. 2 and FIG. 3) or a combination of the two. Multiple metallic springs and elastomeric springs can be stacked vertically to obtain the desired spring characteristic.

The metallic spring(s) could sit on an elastomer base to protect the metallic spring from shock loading. This case could also be a separate component (refer to FIGS. 6a, b, c, d) integral with the elastomer spring(s) and/or part of the housing floor.

There does not necessarily need to be an even number of metallic and elastomer springs. Some applications may use more metallic springs, while other applications use more elastomeric spring units. The resilient member can be loaded in compression, shear, tension or the combination of the three.

The metallic spring can in some embodiments provide anywhere from 5% to 95% of the vertical load with the balance of the vertical load and the vertical damping provided by the elastomer spring. The ratio of the load provided by the metallic spring versus elastomer spring can be determined based on car type, service environment, vertical damping, fatigue life, cost, stress/strain, dimensional considerations and other engineering conditions.

The overall heights of the springs can be as follows:

Each metallic and elastomer spring has the same overall heights.

Each spring, metallic and elastomeric, has its own unique overall height.

Each metallic spring has the same overall height and each elastomer spring has its own elastomer spring height.

The metallic spring is preferably a steel helical spring, torsion spring, volute spring, leaf spring, or any combination thereof.

The elastomer spring can be made of polyurethane elastomer with a hardness ranging from 30 Shore A to 80 Shore D made, such as for example:

MDI polyester cured with HQEE or 1,4 butandiol polyurethane;

MDI polycaprolactone cured with HQEE or 1,4 butandiol polyurethane;

MDI polyether cured with HQEE or 1,4 butandiol polyurethane;

Foam, rubber or other elastomeric material.

The elastomer spring could be made from rubber (natural or synthetic) such as with a hardness ranging from 30 Shore A to 80 Shore D, any material that possesses high damping characteristics (large hysteresis) or any combination of the above materials will usually be desirable.

The metallic and/or elastomer springs may include a structure to assist in positioning these springs relative to the wear cap and/or housing. One such mechanism is to use a hole, through bore or blind, in the springs in combination with a post or boss on the wear cap and/or housing or vice versa. The springs may include a centerhole (refer to FIG. 2) rather than being a solid cylinder (refer to FIG. 3) to improve the vertical deflection characteristics. The elastomer spring can be bonded to another substrate such as another elastomer, metal, etc. in order to provide force-deflection characteristics, ease of assembly, etc.

The housing can be fastened to the truck bolster via bolts, rivets, etc., welded directly to the bolster, or inserted into existing bolster pocket which is integral with or has been attached to the truck via fasteners, rivets, welding, etc. The housing can be made of steel, ductile iron, or austempered ductile iron. The housing can be produced from a standard shape such as for example: bar, plate, round channel, by forming, forging, casting and/or fabrication of one or more of these. The housing can have a floor that is integral with the entire housing, open on the bottom allowing the resilient member to contact the bolster, or have a separate base that attaches to the housing to form a floor for the resilient member (refer to Stucki published patent application Ser. No. 10/939,667 for Modular Base Side Bearing). The thickness of the housing floor can be varied to provide different preloads or vertical travel and/or satisfy AAR non-interchangeability requirements. The housing could incorporate an insert or sleeve made of metal (such as brass) or non-metallic material (such as polyurethane) to provide additional vertical and longitudinal stiffness and/or reduce wear. This insert or sleeve can be attached to the housing mechanically, chemically (bonded), or any combination of the two. Also, different floor heights can be used for the metallic and elastomeric spring member.

The wear cap can be made of steel, ductile iron, or austempered ductile iron. The wear cap can be produced from a standard shape (bar, plate, round, channel, etc.) forming, forging, casting, and/or fabrication of one or more of these. The wear cap could include an insert of metal (such as brass) or non-metallic material (such as nylatron, plastic, thermoplastic urethanes or the elastomer spring portion of the hybrid spring) located between the top of the wear cap and underside of the car body or between the wear cap and housing to provide additional resistance to thermal degradation and/or additional resistance to wear. This insert or sleeve can be attached to the housing mechanically, chemically (bonded), or any combination of the two. The wear cap can have different thickness to provide different column heights for the metallic and elastomeric elements.

Although the typical CCSB includes a wear cap and housing as described above, there may be applications where a wear cap and/or housing would be unnecessary in the CCSB.

### BRIEF DESCRIPTION OF THE DRAWINGS

FIG. 1 is a graph showing a comparison of energy dissipation between mechanical springs and elastomeric columns.

FIG. 2a is a perspective drawing of an embodiment of a CCSB.

FIG. 2b is a plan view of the embodiment shown in FIG. 2a.

FIG. 2c is a perspective view shown in section of the CCSB shown in FIG. 2a.

FIG. 2d is a drawing of a cross-sectional view taken from FIG. 2b.

FIG. 3a is a perspective drawing of a different embodiment of a CCSB utilizing two metallic springs and two elastomeric blocks.

FIG. 3b is a cross-sectional view of the CCSB shown in FIG. 3a.

FIG. 3c is a plan view of a cage and a metal cap of the embodiment of FIG. 3a.

FIG. 3d is a cross-sectional view of the CCSB of FIG. 3c.

FIG. 4a shows a perspective view of a combined metallic and elastomeric spring for use in a CCSB.

FIG. 4b is a cross-sectional view of the molded combined spring of FIG. 4a.

FIG. 4c is a top plan view of the embodiment shown in FIG. 4a.

FIG. 4d is cross-sectional view taken of FIG. 4c.

FIG. 5a is a perspective view of a metallic spring having a molded elastomeric spring contained on the coils thereof.

FIG. 5b is a cross-sectional view of the device shown in FIG. 5a.

FIG. 5c is a plan view drawing of the embodiment of FIG. 5a.

FIG. 5d is a cross-sectional drawing of the embodiment shown in FIG. 5c.

FIG. 6a shows a perspective view of an embodiment using the coiled metallic spring on top of an elastomeric spring.

FIG. 6b shows a cross-sectional view of the device of FIG. 6a.

FIG. 6c is a drawing of a top view of the device of FIG. 6a.

FIG. 6d shows a cross-sectional view of the device of FIG. 6c.

FIG. 7 is a plan view of another embodiment shown without cap.

FIG. 8 is plan view of another embodiment shown without cap.

FIG. 9 is a plan view of another embodiment shown without cap.

FIGS. 10a, b, c are various views of another embodiment of an elastomer block, with a tapered contour to control deflection.

FIGS. 11a, b, c are various views of another embodiment of a block with a metal and elastomer block.

FIGS. 12a, b, c are various views of another embodiment.

FIGS. 13a, b, c are another embodiment with a co-axial metal spring.

### DETAILED DESCRIPTION OF SOME EMBODIMENTS

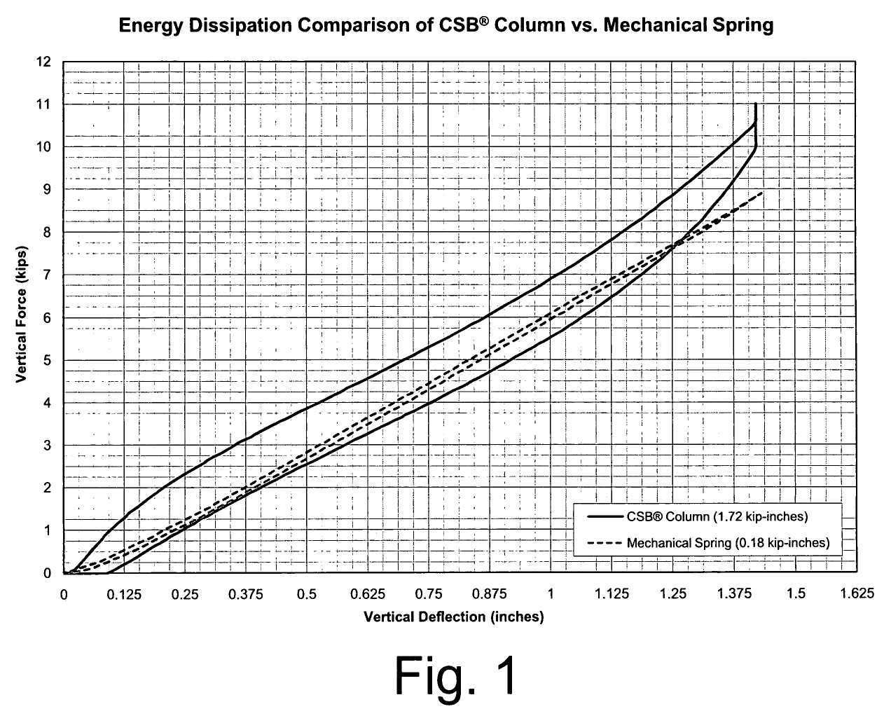

FIG. 1 is a graph showing the energy dissipation and compares an elastomeric CCSB column from a constant contact side bearing with a metallic spring. This CCSB column shows the hysteresis in the deflection of the elastomeric column. As can be seen in the dashed line, the mechanical spring has some hysteresis but is generally greatly reduced from that of an elastomeric side bearing column.

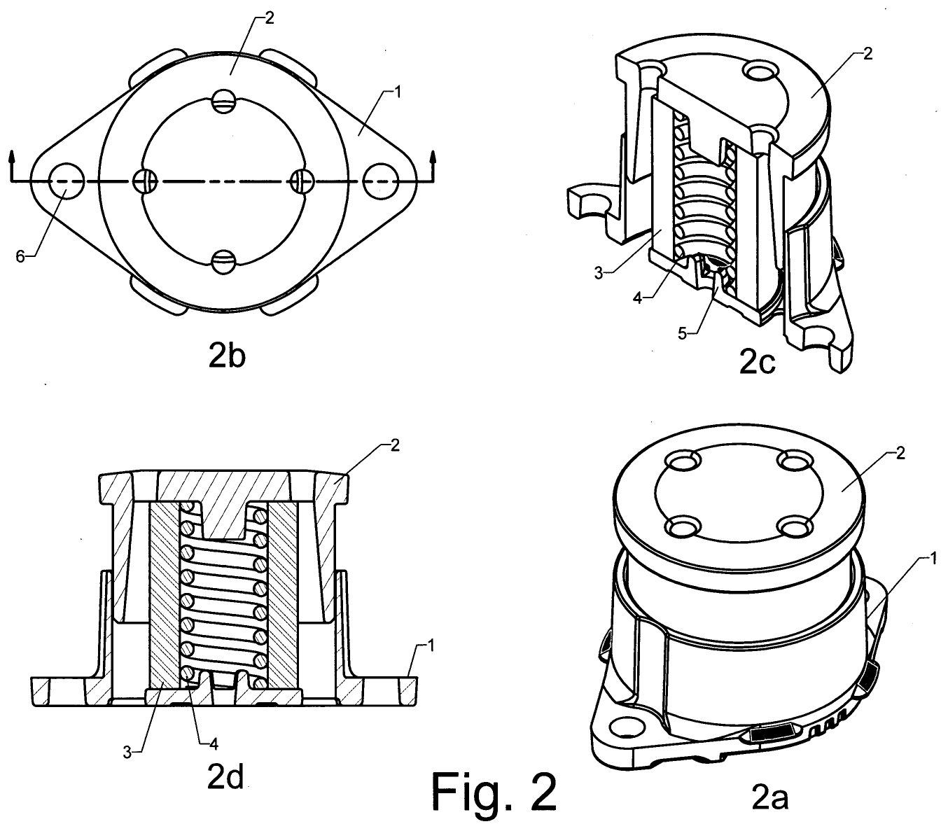

FIGS. 2a, b, c, d show an embodiment in a generally cylindrical shape constant contact side bearing. As seen in FIG. 2a, a housing or cage 1 is fitted with a metallic cap 2 which can be telescoped-within the lower housing. This permits the bearing to be aligned and the alignment maintained and in addition can act to keep undesirable debris out of the constant contact side bearing area. As shown in FIG. 2a, holes can be provided for mounting the constant contact side bearing on the bolster or other areas. The device can be bolted or equally can be welded or use other attachment means. While shown as a cylindrical device in FIG. 2a, it is to be understood that it can also be made as a rectangular device or any other shape which the specific railway car application might suggest. FIG. 2b is a plan view of the device shown in FIG. 2a. As can be seen, there are some additional holes in the metallic cap 2. FIG. 2c is a cross-section of the device shown in FIG. 2a and shows the device having an elastomeric hollow cylinder shaped spring 3. Nested within the central hollow portion of the elastomeric spring 3, is a metallic spring 4. In the embodiment shown, a spring seat 5 is shown in the device. The spring seat can be separate or can be an integral part such as a casting in the lower housing 1. It could be modular to provide various different column heights. The concentric metallic spring 4 and the elastomeric spring 3 are shown in FIG. 2d. FIG. 2d also shows how the metal cap 2 can be telescoping within the base 1. As can be seen in FIGS. 2c and d, the elastomeric spring 3 and the metallic spring 4 are generally concentric, and as the cap 2 is depressed by normal railway freight car dynamics, both springs compress. Either spring may be installed initially with a preset load. In some cases the preset load for the metallic spring can be higher than the preset load for the anatomic spring, or the opposite presets can be used. As the cap 2 is depressed, both the metallic spring and the elastomeric spring are caused to also compress. The result is that the effective spring forces upward on the cap from the metallic and elastomeric springs provide for the characteristics of both the elastomeric and metallic compressions. In some instances, it would be desirable to have the elastomeric element with no preload and possibly even some free travel before the cap 2 starts to compress the elastomeric spring. As has been discussed, any form of metallic spring may be used although coil springs are presently preferred for the metallic versions. In addition, the elastomeric spring may be of any material that provides for the desired characteristics as it is compressed. As shown in FIG. 2, the elastomeric spring can be a generally hollow cylindrical structure. However, it is to be understood that the thicknesses and size of the elastomeric spring 3 may be tapered, curved or any other shape which fits the given application. Generally, the central bore is of a size to accommodate the metallic spring 4. It is also to be understood that a reverse version in which the metallic spring 4 is outward of an elastomeric element. FIGS. 2c and d also show that the cap 2 can have a boss or protuberance out of the inward side which provides for retaining the alignment between the respective spring elements. Similarly, the modular base or spring seat 5 has an upward boss or fingers that provide for centering the lower portion of the spring elements.

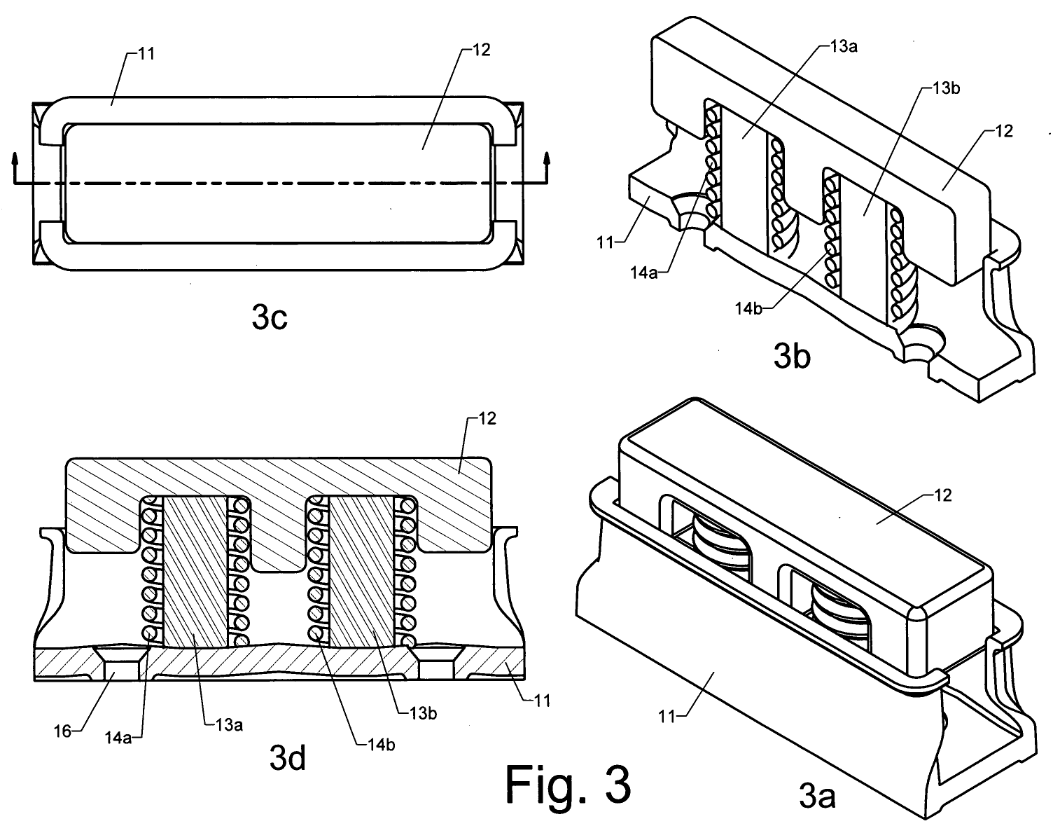

FIG. 3 shows another embodiment in which a more traditional rectangular shaped constant contact side bearing cage 11 is used with a metal cap 12. In this embodiment, there are two columns of springs. Each column includes metallic spring 14a, 14b and nestled within the center of the metallic helix spring is an elastomeric spring 13a, 13b. The metallic springs 14a and 14b can be of any size but are usually chosen so as to complement the elastomeric spring characteristics. In FIG. 3b, the metal cap 12 also includes portions which can be guided on the cage 11 and also act as a spring seat on the upper portions of the combined elastomeric/metallic spring sets 13a/14a and 14b/13b. More detail is shown in FIGS. 3c and 3b of the embodiment shown in FIG. 3a.

The embodiments shown in FIGS. 3a-d use a rectangular cage and two sets of metallic/elastomeric springs. However, it is to be understood that rectangular cages can be utilized using only a single elastomeric block in combination with one or more metallic springs. Similarly, it is be desirable in some applications to utilize multiple elastomeric blocks and use only a single metallic spring. As shown, the concentric arrangement of each spring assembly includes a central cylindrical elastomeric element such as 13b surrounded by a helical coil metallic spring 14b. Other applications could include a spring placed centrally within the assembly and an elastomeric outer element such as was described in FIG. 2. In some applications it may be desirable to utilize a spring seat under each spring/elastomeric element. The spring seat could be part of a unitized cage 11 or could be a separate modular unit. In some applications, it may be desirable that spring seat under the metallic spring includes an elastomeric material. The rectangular cage assembly of FIG. 3 could also utilize vertically stacked alternate layers of elastomeric and metallic springs. Again, the specific number of metallic springs and their spring coefficients along with the elastomeric elements will be determined by the specific dynamics of the vehicle to which the specific constant contact side bearing would be applied.

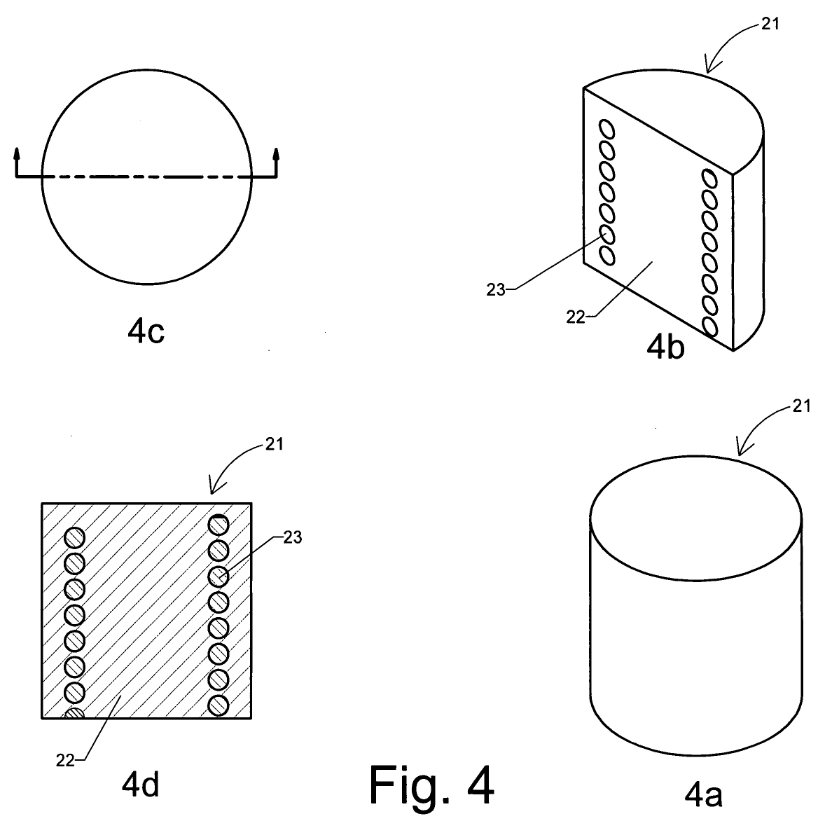

FIG. 4 shows a spring column for use in a constant contact side bearing. FIG. 4a shows a generally cylindrical molded column 21. FIG. 4b is a cross-section of FIG. 4a and shows that a metallic coil spring 23 is encapsulated within an elastomeric material 22. FIGS. 4c and 4d show more detail with regard to the embodiments shown in FIGS. 4a and 4b. It is to be understood that metallic spring 23 could extend beyond the limit of the elastomeric material. Similarly, it may be desirable in some applications that the elastomeric material 22 extend beyond the vertical length of the metallic spring 23. In some embodiments, it may be desirable to use multiple coil springs that are nested coaxially with each other.

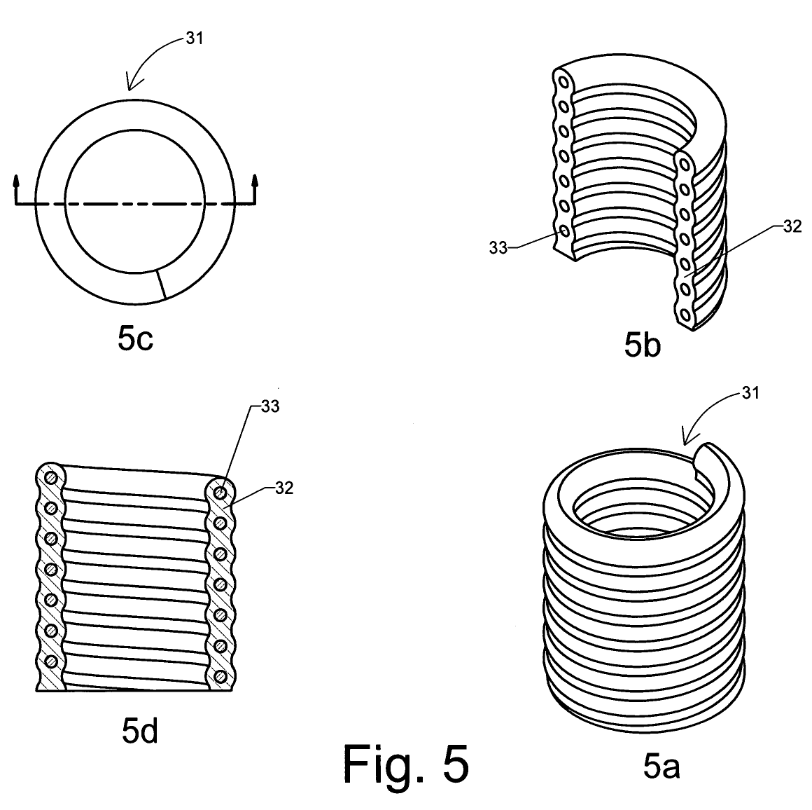

FIG. 5 shows another embodiment of the invention in which a device 31 includes a metallic spring 33 encased within a molded elastomeric spring material 32. While this provides both characteristics of the metallic spring and the elastomeric spring, the open portion can also be utilized to nest other metallic springs or other metallic/elastomeric combinations. FIGS. 5c and 5d show more detail of the column shown in FIG. 5a. As shown, the elastomeric material 32 in FIG. 5d can be of any thickness. It may be desirable in some applications to have the radially outward sidewall of 32 be in close proximity to the side of the constant contact side bearing cage. Similarly, material may be also added to the inner diameter of the elastomeric material 32. As compressed, the elastomeric material will desire to flow and the constraint of such flow can be utilized to achieve desired dynamic characteristics.

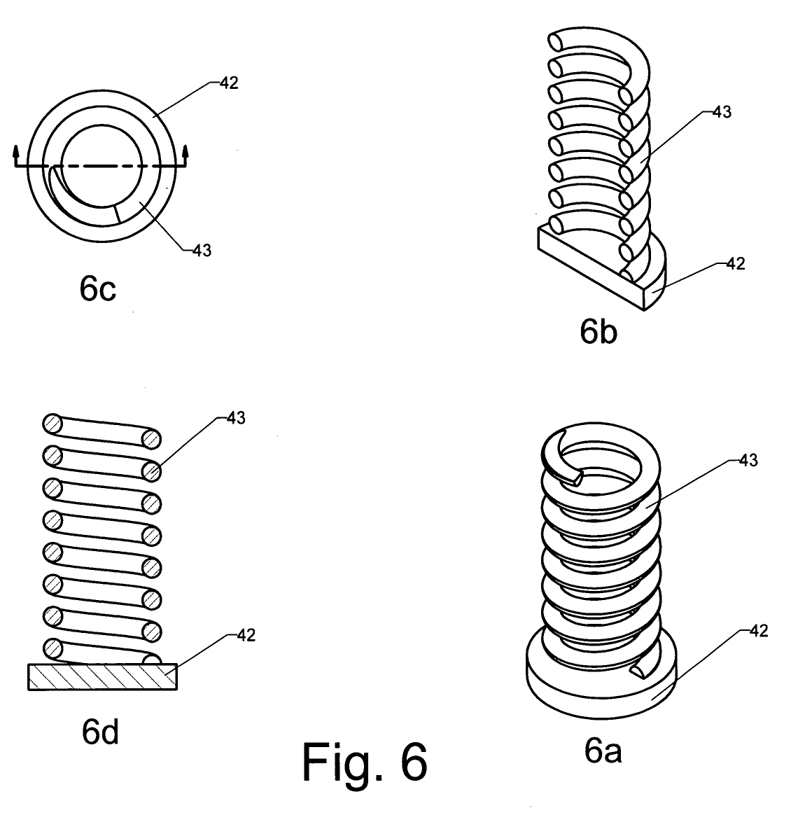

In the embodiments shown heretofore, the elastomeric spring and the metallic spring can be thought of working in a parallel arrangement. However, a column can be utilized using both the elastomeric spring and the metallic spring in which the two devices are in a series arrangement such that the same force will appear generally in both the metallic and the elastomeric column members. FIG. 6a shows a metallic spring 43 that is seated on an elastomeric spring 42. FIG. 6b shows a cross-section of the device of FIG. 6a. As shown, the elastomeric material 42 has a flat upper surface, however, it may be desirable to mold such upper surface into a spring seat to maintain the proper geometric relation between the metallic spring 43 and the elastomeric spring 42. As shown, the elastomeric spring 42 has as relatively small vertical length and the metallic spring 43 has a considerably longer vertical length of the overall column. However, it is to be understood that the relative sizes between the metallic spring 43 and the elastomeric spring 42 can be varied to optimize the characteristics for any given application. FIGS. 6c and 6d show other details of the device of FIG. 6a. While FIG. 6 shows a single metallic spring and a single elastomeric element 42, it is to be understood that multiple elastomeric and metallic springs may be utilized in the vertical direction, stacked, to achieve the desired physical characteristics. In addition, it may be desirable to utilize a metallic seat between the metallic spring and the elastomeric spring such that the force carried vertically by the metallic spring is spread evenly across the mating surface of the elastomer 42.

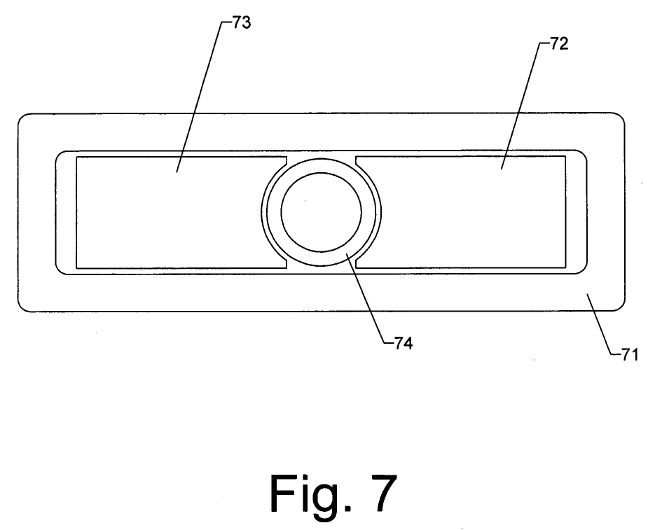

FIG. 7 is a top elevational view of a cage having a single metallic coil spring 74 and two elastomeric columns 72 and 73. As can be seen, the columns 72 and 73 have been molded to extend around the central spring 74 in cage 71. While this drawing does not show a metallic cap, it is to be understood that a metallic cap can also be utilized with the arrangement in a rectangular cage 71. Similarly, the elastomeric elements 72 and 73 could be rectangular without the molded fit around spring 74. In some embodiments, it may be desirable to use cylindrical elastomeric elements 72 and 73. In such designs, it may be desirable to use a cap that has some type of elastomeric and metallic spring alignment surfaces. Similarly, the cage may have a modular bottom which also includes specific raised elements to align the metallic or elastomeric springs.

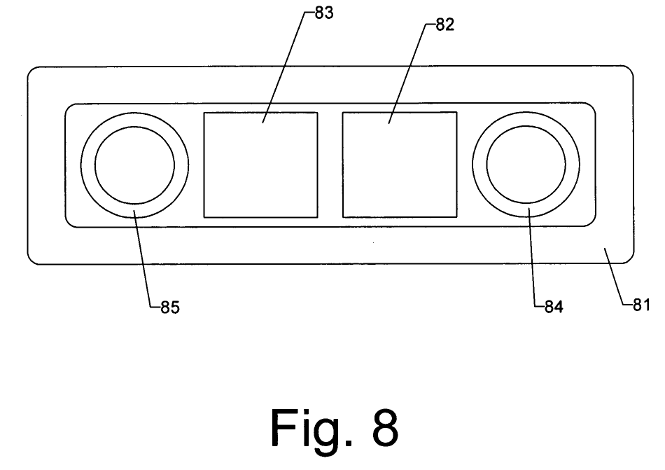

FIG. 8 shows another plan view of a cage 81 without a cap, however, a cap would also be added. In this arrangement, the elastomeric blocks 82 and 83 are utilized in combination with metallic coils springs 85 and 84. It is to be understood that any arrangement of the elastomeric springs or blocks can be used with any number of other arrangements of coiled or other style springs. In addition, while it may be desirable to have symmetry within the CCSB, it is to be understood that nonsymmetrical arrangements can also be utilized within the scope of the invention. As shown, the two metallic coil springs 84 and 85 are single springs. However, in many applications, it would be desirable to include a smaller diameter coiled spring within spring elements 84 and 85. Any number of nested concentric spring can be usually utilized to change the characteristic and provide the maximum amount of metallic springs within a given footprint.

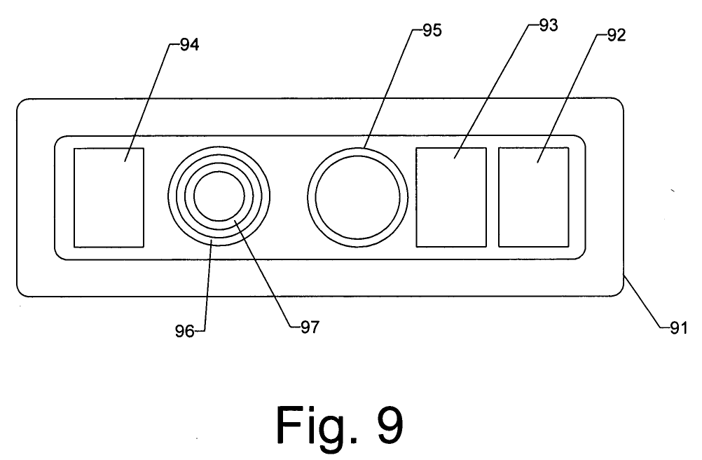

FIG. 9 shows a cage 91 having three elastomeric blocks 92, 93 and 94. In addition, a coil spring 95 is located within the cage 91. Also shown are a set of metallic coiled springs 96 and 97 which are nested within each other. While only one spring is shown in this drawing having within it a nested coil spring, it is to be understood that 95 could also use an additional metallic spring if so desired. By the same token, while the designs have shown generally elastomeric blocks such as 94, 93 and 92, it is to be understood that the invention could also be practiced using cages having open coil springs and columns such as shown in FIG. 3. Some embodiments can have elastomeric within a coil spring such as FIG. 4 wherein a column is composed of a metallic spring molded with an elastomeric spring into a single unit. Multiple units such as shown in FIG. 4 could also be used in the embodiment shown in FIG. 9.

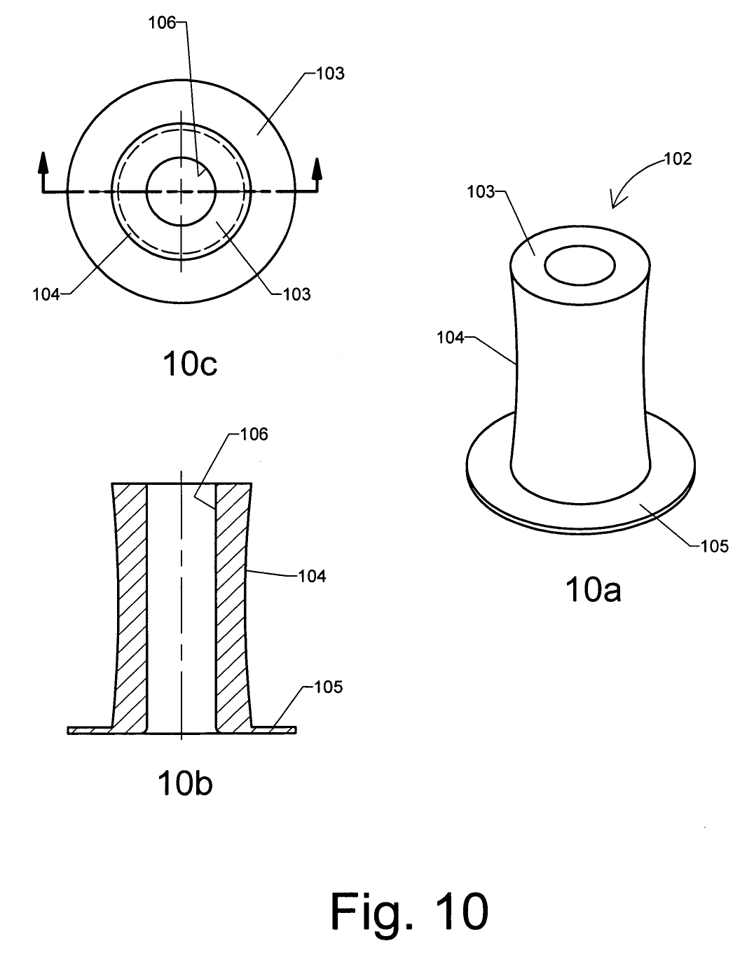

FIGS. 10a, b, c show the embodiment of a molded elastomeric spring element 102. Element 102 can be used in a number of embodiments of combined metallic and elastomeric spring constant contact side bearings, such as, for example, that shown in FIGS. 2 and 3. While the metallic spring is not shown in FIG. 10, it is to be understood that as shown in the other figures, such a device could use a helical outer spring having the elastomeric unit 102 in the center of the coil metallic spring. As such, the elastomeric unit of FIG. 10 provides a flange 105 which acts as spring seat. It is understood that that the thickness of 105 may be increased significantly such as to provide the additional elastomeric spring below the coil spring. This is similar to what was shown in FIG. 6a. However, the elastomeric element 42 of FIG. 6a is now included within the flange seat 105. Additionally shown in element 102 is a central bore 106 which is generally cylindrical. However, in some embodiments, a certain amount of arc or taper to the center bore 106 may be desirable. As can be seen in FIGS. 10b and c, the outer surface has a diameter that varies with the height of the elastomeric column. As such, the embodiment of FIG. 10 has a narrow taper in the outer surface 104. This provides for different spring characteristics as the element 102 is compressed. The taper can be concave or convex, and maybe a series of straight tapers, curves or arcuate. It may be beneficial for some applications to use both concave and convex tapers on the surface 104.

The ratio of the load provided by the metallic spring versus elastomer spring is generally determined based on one or more of the following: car type, service environment, vertical damping, fatigue life, cost, stress/strain, and dimensional considerations. The spring can be loaded in one or more of the following: compression, shear, tension or a combination such. The metallic spring can provide in the range of 5% to 95% of vertical load; and the balance of the vertical load and the vertical damping primarily provided by the elastomer spring. The metallic springs can be steel and can be a helical spring, torsion spring, leaf spring or combinations of such. The elastomer spring can be a polyurethane elastomer with a hardness generally in the range from 30 Shore A to 80 Shore D. The elastomeric material can include one or more of the following: MDI polyester cured with HQEE or 1,4 butandiol; MDI polycaprolactone cured with HQEE or 1,4 butandiol; or MDI polyether cured with HQEE or 1,4 butandiol, or a foam material. Some embodiments may use an elastomer spring made of a rubber material with a hardness ranging from 30 Shore A to 80 Shore D. The elastomer spring can be bonded to another substrate such as another elastomer, metal, etc. in order to provide the desired force-deflection characteristics. The constant contact side bearing housing can be fastened to the truck bolster via bolts, rivets. or welded directly to the bolster or inserted into existing bolster pocket which is integral with or has been attached to the truck via fasteners, rivets, or welding.

The constant contact side bearing wear cap can include an insert of metal (such as brass) or non-metallic material (such as nylatron or the elastomer spring portion of the hybrid spring) disposed between said wear cap and said car body to provide additional resistance to thermal degradation and/or additional resistance to wear. This insert can be attached to the wear cap by mechanically, chemically, or other structure. The constant contact side bearing can have a housing that incorporates an insert or sleeve made of metal (such as brass) or non-metallic material (such as polyurethane) to provide additional vertical and longitudinal stiffness and/or reduce wear. This insert or sleeve can be attached to the housing by mechanical, or chemical attachment. The constant contact side bearing can include a stop for limiting the vertical travel (deflection) by interaction of existing components such as the housing and wear cap, or by additional mechanical stops. The constant contact side bearing can have the metallic spring is attached to an encapsulated elastomer spring by mechanically or chemically bonding to the metallic spring.

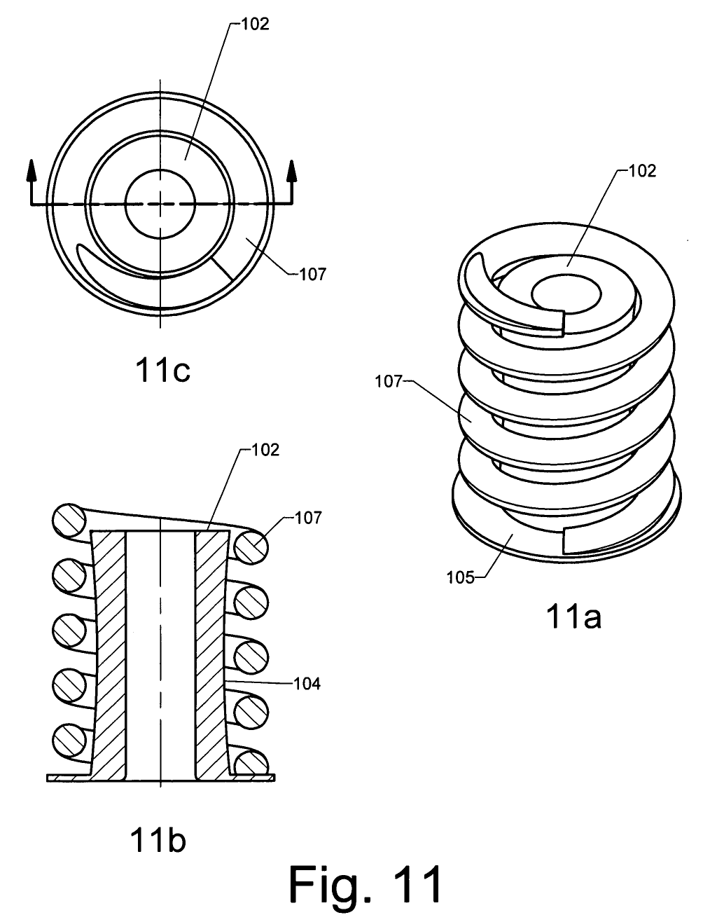

FIG. 11 shows an elastomeric element 102 such as shown in FIG. 10 with an outer helical coiled metallic spring 107. A lower portion of the metallic spring 107 is resting on the flange of elastomeric material 105. The flange provides a soft seat for the metallic spring and also provides for alignment between the metallic spring 107 and the elastomeric spring 102.

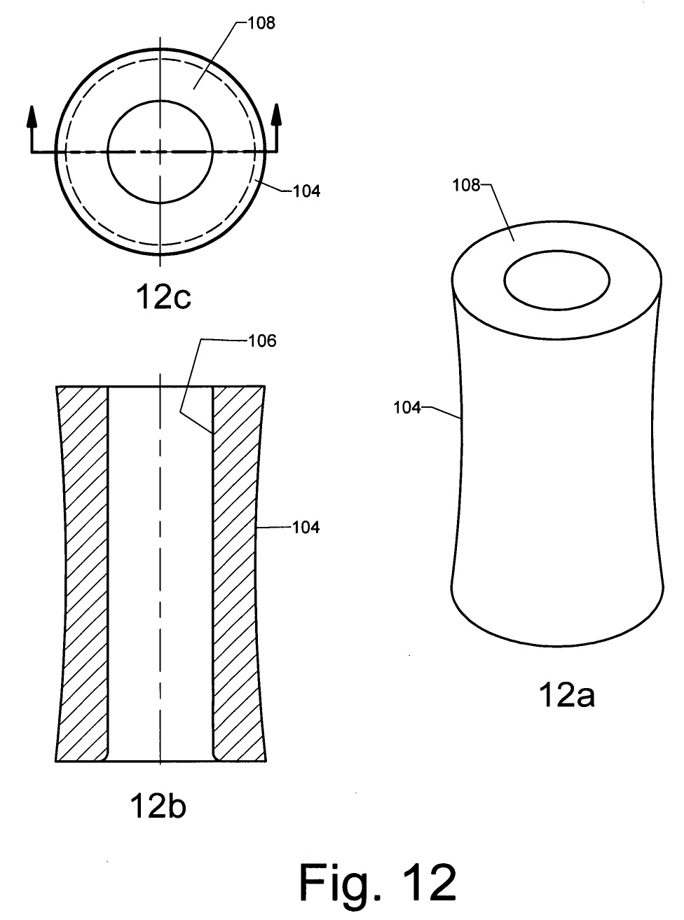

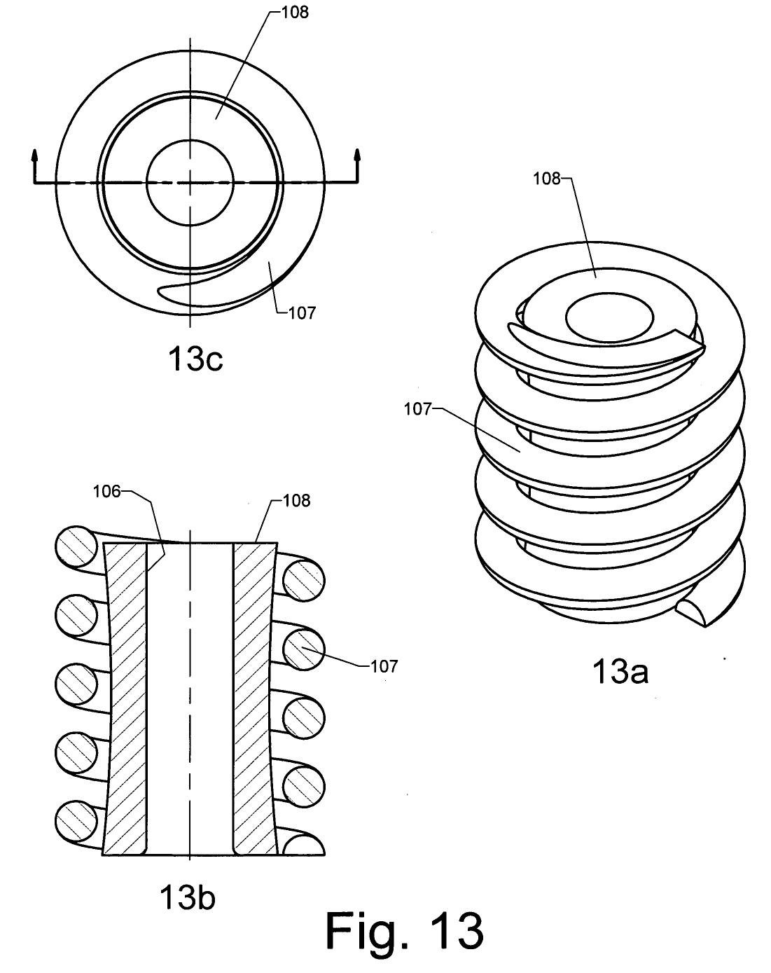

FIG. 12 shows an elastomeric element having a tapered outer surface 104 and a generally cylindrical inner surface 106. The degree of taper as shown in FIG. 12c between the dotted line and the outer surface can be varied to achieve the proper elastomeric characteristics for a specific application. It is to be understood that elements such as 108 and 102 may be used with a concentrically mounted metallic coil spring. However, the element 108 as shown in FIG. 12 can be utilized with a generally cylindrical cage or with a rectangular cage; neither of the rectangular or cylindrical cages need to have metallic springs. The advantage of having the outer tapered surface 104 permits maximum elastomeric characteristics for a given rail application. However, the same elastomeric block 108 can be utilized in conjunction with metallic springs as shown in FIG. 13.

FIG. 13 shows elastomeric block 108 having a cross spring 107 around it. In addition, the block 108 has a cylindrical inner bore 106. In utilizing the embodiment as shown in FIG. 13, a separate boss on the cap can fit into the cylindrical bore 106. The boss may be on the cap and/or on the lower surface within the cage for housing.

When these embodiments have shown the outer taper on the surface of 104 of an elastomeric spring for a constant contact side bearing, it is to be understood that the inner surface 106 may contain a light taper to provide additional contouring to optimize the spring characteristics of the elastomer as it is compressed. It may be desirable to keep the outer surface at a constant diameter while the inner surface 106 maintains a taper that varies the compression characteristics. In addition, it may be desirable to have cylindrical elastomeric units used within the metallic coil spring so as to center the elastomeric portion of the spring elements and limit the lateral flow of the elastomeric material. Similarly, it may be desirable to maintain a preset distance between the elastomeric material and the metallic spring so as to permit the elastomeric material some radial outward movement before contacting the metallic spring.

While certain embodiments have been shown, it is understood that the concept of using metallic and elastomeric spring elements within a constant contact side bearing may be utilized in other embodiments within the scope of this attached claims.

1. A railway freight car constant contact side bearing as bearing between a railway vehicle body and a wheeled truck supporting said railway freight car body, comprising:
a housing;
a bearing cap;
a plurality of springs disposed within said housing to apply a pressure to said cap; and
said plurality of springs comprises at least one metallic spring and at least one elastomer spring.

2. The constant contact side bearing of claim 1 further comprising: said metallic spring provides in the range of 5% to 95% of vertical load; and the balance of the vertical load and the vertical damping provided by the elastomer spring.

3. The constant contact side bearing of claim 1 wherein said metallic and elastomer springs have generally the same overall heights.

4. The constant contact side bearing of claim 1 wherein said metallic spring has a generally different overall height from said elastomer spring.

5. The constant contact side bearing of claim 1, wherein said elastomer spring is a rubber material with a hardness ranging from 30 Shore A to 80 Shore D.

6. The constant contact side bearing of claim 1, wherein said elastomer spring is a material that possesses high damping characteristics with a substantial hysteresis.

7. The constant contact side bearing of claim 1, wherein said elastomer spring is bonded to another substrate including at least one of an another elastomer and a metal spring.

8. The constant contact side bearing of claim 1, wherein said housing has a modular base beneath at least one of said springs.

9. The constant contact side bearing of claim 1, wherein said elastomer spring comprises at least one metallic spring encapsulated within an elastomer spring.

10. The constant contact side bearing of claim 1, wherein said at least one elastomer spring includes a generally cylindrical spring having a flange extending outward; and
said at least one metallic spring is co-axial about said cylindrical spring and said metallic spring is seated on said flange.

11. The constant contact side bearing of claim 1, wherein said at least one elastomer spring comprises a generally cylindrical shaped spring having an outer surface of said cylindrical shape and said outer surface having a taper.

12. The constant contact side bearing of claim 11, wherein said taper is generally concave.

13. The constant contact side bearing of claim 11, wherein said surface is convex.

14. The constant contact side bearing of claim 1, wherein said at least one elastomer spring comprises a generally cylindrical shaped spring having a through-bore; and said through-bore having a tapered inner surface portion.

15. The constant contact side bearing of claim 10, wherein said cylindrical spring includes a generally tapered outer surface.

16. The constant contact side bearing of claim 1, wherein said at least one elastomer spring comprises a generally cylindrical shaped elastomer spring and said at least one metallic spring comprises a metallic coil spring generally co-axial with said elastomer spring.

17. The constant contact side bearing of claim 1, wherein said housing is generally rectangularly shaped; and said at least one metallic spring centrally positioned in said housing; and said elastomer spring comprises at least one elastomer spring on opposite sides of said metallic spring centrally positioned.

18. The constant contact side bearing of claim 17, wherein said housing is generally rectangularly shaped; and said at least one elastomer spring centrally positioned in said house; and said metallic spring comprises at least one metallic spring on opposite sides of said elastomer spring centrally positioned.

19. A constant contact side bearing for a railway vehicle comprising:
a housing;
a cap;
at least one elastomer spring within said housing;
said spring having a generally cylindrical shape having a top surface in contact with said cap and a bottom surface in contact with said housing; and
an outer surface having a tapered portion.

20. The constant contact side bearing of claim 19, wherein said tapered surface is concave.

21. The constant contact side bearing of claim 19, wherein said tapered surface is convex.

22. The constant contact side bearing of claim 19, wherein said elastomer spring has a generally axial through-bore.

23. The constant contact side bearing of claim 22, wherein said through-bore has a generally tapered inner surface.

24. A method for controlled railway vehicle dynamics between a vehicle body and a railway truck within a constant contact side bearing comprising:
supporting a vertical load with a metallic spring constant; and
providing vertical dampening compression of an elastomer spring having hysteresis.

25. The method of controlling railway vehicle dynamics of claim 24, further comprising supporting 5% to 95% the vertical load with a metallic spring constant; and
supporting the balance of the vertical load with an elastomer spring.
